(19) United States
(12) Patent Application Publication
(10) Pub. No.: US 2018/0143867 A1
(43) Pub. Date: May 24, 2018

(54) Mobile Application for Capturing Events With Method and Apparatus to Archive and Recover

(71) Applicant: AT&T Intellectual Property I, L.P., Atlanta, GA (US)

(72) Inventors: Sheldon Kent Meredith, Roswell, GA (US); William Cottrill, Canton, GA (US); James Egan, Cumming, GA (US)

(21) Appl. No.: 15/358,805

(22) Filed: Nov. 22, 2016

(51) Int. Cl. G06F 9/54

(52) U.S. Cl. CPC G06F 9/541

(57) ABSTRACT

A method includes receiving a command to activate an application, responsive to the receiving step, determining a set of data collection functions to initialize, responsive to the determining step, initializing the data collection functions, correlating data captured by the data collection functions to create event data, and causing the event data to be stored in a retrievable record.

### TECHNICAL FIELD

Embodiments of the present inventions relate to methods and systems for capturing data relating to an event, and more particularly to methods and systems for an application that enables multi-mode recording, capturing and recovering of the event.

### BACKGROUND

Throughout our daily lives, there is the need to capture various things happening around us, but a notebook and pen may not be readily available to do so. It may be possible to quickly capture a voice note or a photograph and sometimes this can be a bit cumbersome depending on what else we are doing. There may be a desire to capture different kinds of events or items which require different methods of capture. With such disparate mechanisms to capture pieces of information relating to an event, there is no assurance that something will not be missed.

Even if all the information was able to be captured, there is no mechanism for collating and storing that information for subsequent retrieval.

### SUMMARY

A non-limiting summary of the disclosure involves a method including receiving a command to activate an application, responsive to the receiving step, determining a set of data collection functions to initialize, responsive to the determining step, initializing the data collection functions, correlating data captured by the data collection functions to create event data and causing the event data to be stored in a retrievable record. The method may further comprise responsive to the receiving step, determining a location and wherein the correlating step includes correlating the location with the event data, and setting a time period wherein data from the data collection functions is time-stamped and the correlating step correlates data during the time period. In an aspect, the time period may include a first time period prior to the receiving step and a second time period after execution of the receiving The method may further include initiating an audio or video recording function during the first time period and wherein the audio or video recording comprises a portion of the event data. The initiating step may be performed as a function of one of remaining battery life in a user device and a connection of the user device to an AC power source. In an aspect the method may include determining a location as a function of the battery life of the user device or the connection of the user device to an AC power source.

In an aspect the method may include recording a voice communication initiated within the time period wherein the recording of the voice communication forms a portion of the event data.

In an aspect, the location may be determined by activating wi-fi communications and recording a MAC address and wherein the MAC address forms a portion of the event data.

In an aspect, the initializing step may include initializing a local recording function and an external recording function and the correlating step includes correlating the recordings created by the local recording function and the external recording function with the event data. The method may include prioritizing the event data for subsequent retrieval.

In accordance with the present disclosure, there is a device including an activation switch, an input/output system for communicatively coupling the device to an input device and a storage source, a processor communicatively coupled to the input/output system, and memory storing instructions that cause the processor to effectuate operations, the operations including receiving a command to activate an application, responsive to the receiving step, determining a set of data collection functions to initialize, responsive to the determining step, initializing the data collection functions, correlating data captured by the data collection functions to create event data, and causing the event data to be stored in a retrievable record. The operations may further comprise setting a time period wherein the time period includes a first time period prior to the receiving step and a second time period after execution of the receiving step. In an aspect, the operations further comprise initiating an audio or video recording function during the first time period and wherein the audio or video recording comprises a portion of the event data. The initiating step may be performed as a function of one of remaining battery life in the device and a connection of the device to an AC power source. In an aspect, the operations further comprise determining a location and wherein the correlating step includes correlating the location with the event data. The operations may further comprise recording a voice communication initiated within the time period wherein the recording of the voice communication forms a portion of the event data.

The operations may further comprise activating a wi-fi communications and recording a MAC address and wherein the MAC address forms a portion of the event data. In an aspect, the initializing step includes initializing a local recording function and an external recording function and the correlating step includes correlating the recordings created by the local recording function and the external recording function with the event data.

The disclosure also includes an application server including an input/output system for communicatively coupling the server to a user device and a storage source, a processor communicatively coupled to the input/output system; and memory storing instructions that cause the processor to effectuate operations, the operations including receiving an activation command from the user device, sending a set of data collection functions to the user device, receiving first data collected by the data collection functions, receiving second data collected during a time period from an external server, correlating the first data and the second data to form event data, and causing the event data to be stored in a retrievable record.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a schematic representation of an exemplary system environment in which the methods and systems to capture event data may be implemented.

FIG. 2 is a functional block diagram of an exemplary system in which methods and systems to capture event data may be implemented.

FIG. 3 is an exemplary process flow of a method of operation in accordance with the present disclosure.

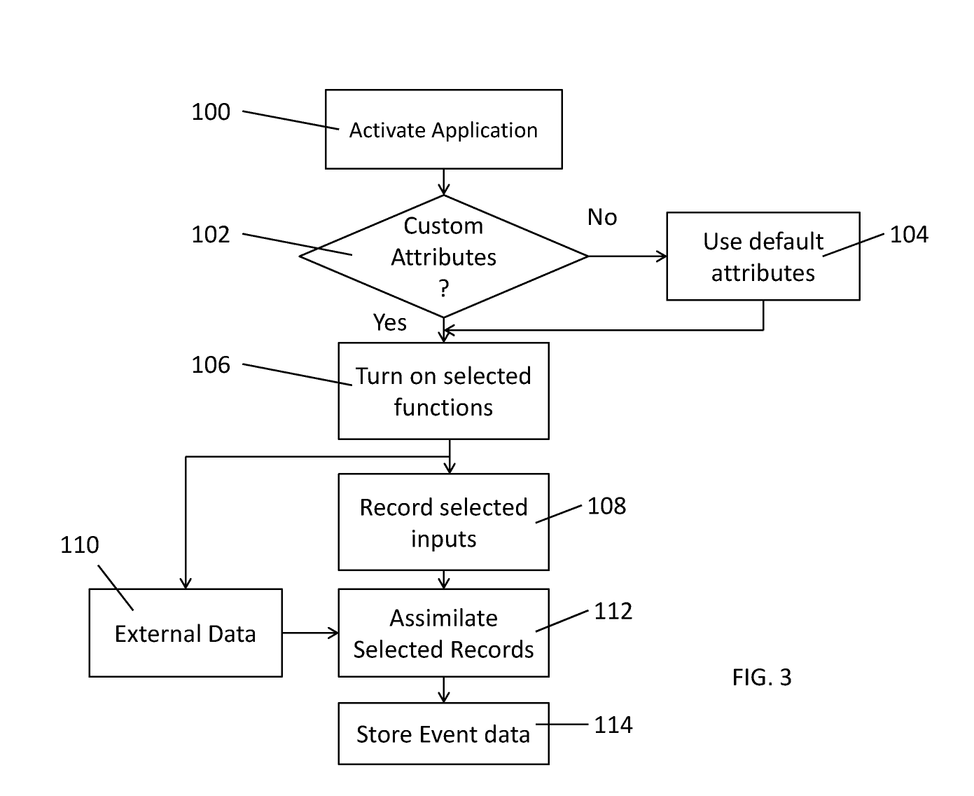

FIG. 4 is a block diagram of an example device that is configurable to be compatible with the present disclosure.

### DETAILED DESCRIPTION OF ILLUSTRATIVE EMBODIMENTS

Overview.

The present disclosure may include a mobile application that is easily and rapidly activated on a smart phone or other user device causing the application to capture event data. In an aspect, there may be a variety of inputs to be captured, including photos, videos, short messaging service (SMS) text messages, multi-mode service (MMS) messages, emails, audio recordings, video recordings, still photographs, airdrops, location, mobility vectors (speed and direction), social media data and screenshots. In an aspect, the application may allow the user to specify time limits during which the inputs forming the event data may be captured. The time limits may, for example, include a start time and end time during which the application would be active and the inputs captured. The start time may, for example, start upon activation of the application or the start time may be prior to the activation of the application in the case where the inputs were active prior to the activation of the application. In an aspect, there may be a score pertaining to the importance of the input data being saved, either the importance of the event data in the aggregate or the importance of components of the event data being captured. The score of the records created is an attribute for creating journey summaries having varying degrees of importance for either the user or the individuals viewing the event data captured by the user.

In an aspect, a user may adjust settings to specify attributes of the application, which may, for example, include the types of input data to be captured, the time limits associated with such capture, the storage media to be used, and other factors associated with capturing the event data. Attributes may also include the identity of users authorized to access the event data which may, for example, be a social media group. In the absence of the user specifying the attributes pertaining to the capture of input data, preconfigured defaults may be used. In an aspect, the device may automatically store the captured data locally and then send the information to a prescribed web location in the cloud. In an aspect, a different mobile or fixed station software application may be used to and edit the captured event data.

System Environment.

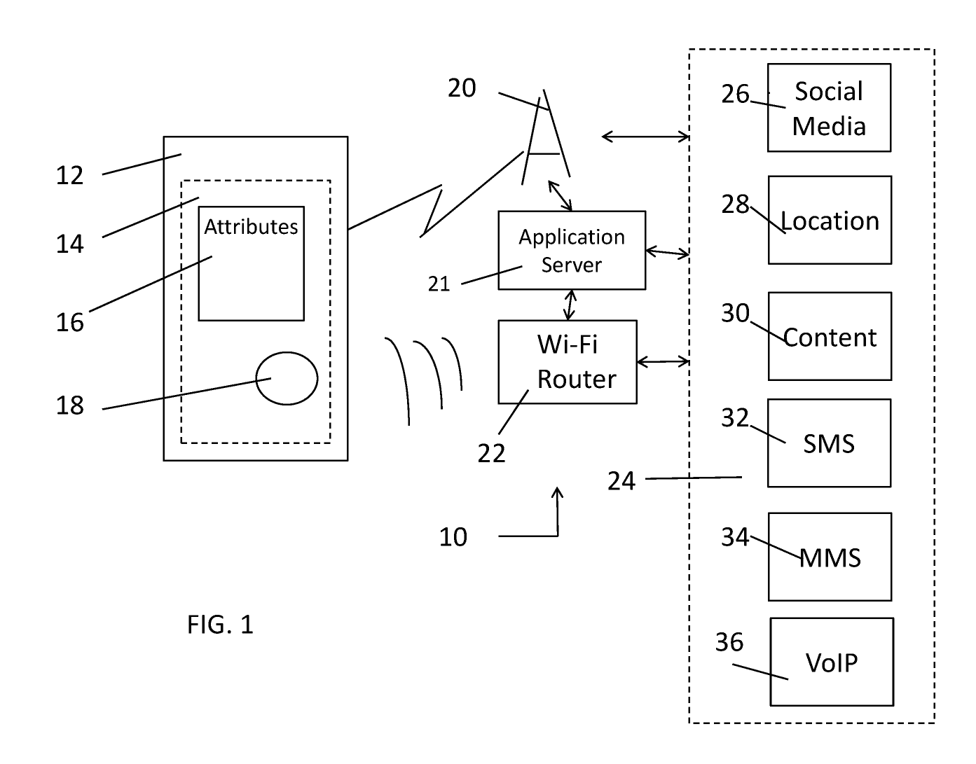

Illustrated in FIG. 1 is a schematic representation of an exemplary system 10 environment in which embodiments of the present disclosure may operate. In the exemplary system 10, there is shown a user device 12 having an application 14 operating thereon. The application 14 may, for example, be a software application that runs on a smartphone or another portable device. The user device 12 may, for example, be configured with an operating system which may, for example, be one of Apple's iOS, Google's Android, Microsoft Windows Mobile, or any other smartphone operating system or versions thereof.

The application 14 may have a settings screen 16 in which certain attributes of the application may be programmed. The attributes may be programmed in advance or may be adjusted after activation of the application 14. The attributes may, for example, include the types of inputs to be captured, which may include audio or video recordings, still photography, location data, time limits, weather or other environmental data, other content, SMS or MMS data, social media data, or any other inputs which may be associated with an event. The attributes may also include options relating to each of the possible inputs to be captured and may include a scoring system that may weigh the relative importance of each. The attributes may also include the preferred storage media, naming conventions, access rights, passwords, or any other attributes relating to the captured data. Each of the possible attributes may be selected or configurable through the settings screen 16.

The application may have an activation switch 18 which may be implemented using a software switch on a touch screen display of the device 14 or may be a physical switch connected integrally or externally to the user device 14. The activation switch 18, when switched to the on position, may be configured to launch the application 12 which thereafter may begin to capture various inputs that may become a portion or the entirety of event data. While shown as a single activation switch 18, it will be understood that the present disclosure is not limited to a single activation switch but may include 2 or more activation switches. Such an activation switch(s) may also be voice-activated or activated based on bio-markers such as fingerprint or pupil recognition. In a multiple activation switch environment or in a software defined activation switch which has multiple configurations, each activation switch may launch different functions of the application 14. For example, one activation switch may launch functions to collect and correlate event data associated with a birthday party and another activation switch may launch functions to collect and correlate event data associated with a college graduation.

In an alternative embodiment, the activation switch 18 may also be programmed to be activated and thereby launch the application 14 upon a trigger based on an external event or an internal schedule. For example, the activation switch 18 may be activated upon receipt of a message signifying the start of an event, which message may be representative of a receipt of an alarm, a cell broadcast, a social media message, a weather or emergency alert, or any other type of message signifying the start of an event. Moreover, the activation switch 18 may be activated based on a daily, weekly or monthly schedule which may correspond to scheduled events.

The user device 12 may have a communication interface for a wireless or wired communication system. In the exemplary configuration of FIG. 1, there is shown a wireless interface to a cellular communication system represented by tower 20. The cellular system 20 may be any type of cellular communication system, including 3G, 46 LTE, 5G, or any other system compatible with the user device 12. Also shown is a Wi-Fi interface 22 in wireless communication with the user device 12. It will be understood that other communication systems compatible with the user device 12 may be included within the scope of the disclosure, including but not limited to local area networks, wide-area networks.

The user device 12 may be in communication with an application server 21 either through the cellular system 20 or Wi-Fi interface 22. The functionality of the application 14 may reside either or the user device 12 or the application server 21 or a combination thereof. Such designation of functionality between the user device 12 and application server 21 may be a design choice or based on user experience, performance, cost, or any other factor. The allocation of functionality between user device 12 and application server 21 is exemplary only and non-limiting in scope of the present disclosure.

Continuing with the description of FIG. 1, the user device 14 may be able to communicate across a communications interface with a variety of servers and/or other applications, represented by external servers 24. Such external servers may include social media 26, which may, for example, include Facebook®, Intsagram®, Snapchat®, Twitter® and any other known or to be developed social media application. It will be understood by those skilled in the art that such social media 26 may supply data to the user device 14 as well as be sent data from the user device 14. The communications between the user device 14 and social media 26 may be time-stamped and filtered in various ways as permitted by the social media applications presently or in the future.

The external servers 24 may also include a location server 28. The location server 28 may be of the type known in the cellular industry and may include GPS, aGPS, triangulation, MAP addresses, or any other type of method for determining the location of the handset 14 or other connected devices or elements. The location server 28 may also support location-based services, including but not limited to mapping functions, cell broadcast alerts, location-based advertising, tracking other nearby devices, or any other of the plethora of location-based services available or to be developed.

The external servers 24 may also include one or more content servers 30. Such content servers 30 may include servers having any type of content, for example, music, entertainment, news, weather, or any other type of content. The external servers 24 may also include short message system (SMS) servers 32 and multimedia system (MMS) servers 34. In an aspect, the external servers 24 may also include a VoIP server 36 to enable voice calling wither across the internet. It will be understood that voice calling may also be implemented across the cellular network 20.

The external servers 24 shown in FIG. 1 are intended to be exemplary only and are not intending to be limiting the present disclosure in any manner. There may be other types of servers that are included in external servers 24 and not all the servers shown as external servers 24 are required within the scope of the present disclosure.

Functional Description.

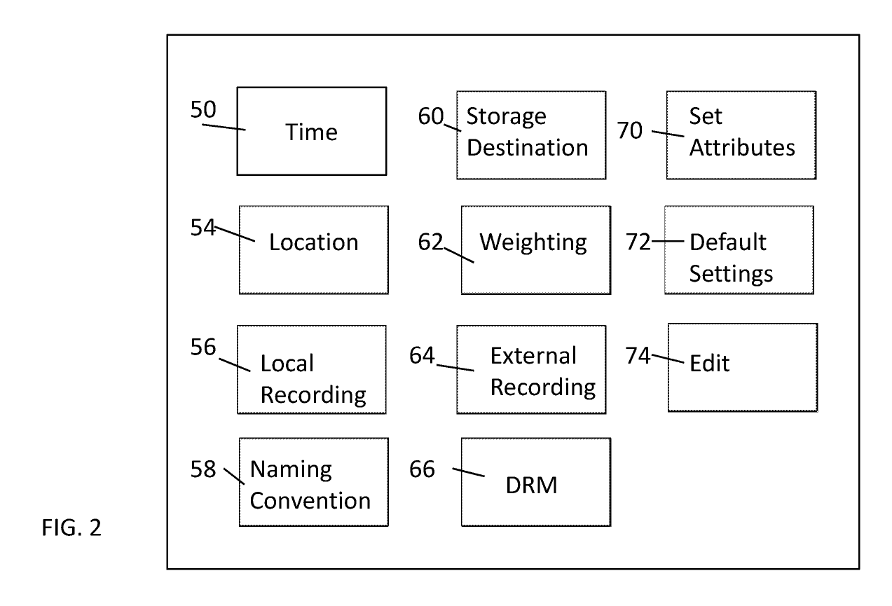

Illustrated in FIG. 2 is an exemplary functional block diagram of an application running on user device 14. It will be understood that the individual functions shown are exemplary only and not all such functions are required, nor are all possible functions shown. Moreover, each of the functions shown may interact with one or more of the other functions shown. While the functions will be described as if such functions are part of an application running on a user device 14, it will be understood that some or all of these functions may reside in a server in communication with the user device 14.

The attributes may be set by the set attributes function 70. The possible attributes may include specifying the types of input data to be captured, the time limits associated with such capture, the storage media to be used, and other factors associated with capturing the event data. The inputs to be captured may include inputs created on the user device 14 or inputs from external servers 24. Attributes may also include the identity of users authorized to access the event data which may, for example, be defined by user names, social media groups, or any other definition. Attributes may be preset or updated dynamically. Multiple sets of attributes may be predefined and then an individual set of attributes selected upon activation. That selected may be based on user inputs or may be based on the event data being captured. For example, one set of attributes may be defined for the capture of a family event while another set of attributes may be defined for the capture of an external event such as a flood or weather storm.

In the absence of the user specifying the attributes pertaining to the capture of input data, preconfigured defaults may be used, represented by default functions 72. The default functions may be used initially during the activation of the application and then changed by the user during the event data capture, or the default functions may be used for the duration of the event data capture.

Continuing with the functional description, the application may have a time function 50 which will enable the time stamping of the event data for subsequent viewing in terms of an event timeline. The time function 50 will also control the time limits for the recording function. In general, the time function may initiate the recording of event data upon activation, in other words, for events for t>t₀ where t₀ represents the activation of the application. In an aspect, the time function may also include gathering information that may have been recorded prior to the activation of the application, i.e., for t≤t₀ as set forth in more detail below. Examples of such prior recordings may include, but are not limited to, retrieving SMS or MMS messages sent or received prior to the initialization of the application but within the time limits created in the set attributes function 70.

The location function 54 may gather the current location at the time of activation using one or more known methods, including GPS, aGPS, MAC addressing, triangulation, manual input, or any other location determination functionality. The location function 54 may operate within the user device 14 or may be received from location server 28. The location function 54 is not limited to static determination of the location at the instantiation of the application, but may be updated periodically or, in an aspect, may also use an accelerometer and compass built into the user device 14 to track and record motion of the user device 14 within the time limits.

The local recording function 56 may be activated to record event data that is being generated or received by the user device 14. For example, the local recording function 56 may record location information from the location function 54 to the extent that location information is being generated by GPS on the user device 14. The local recording function 56 may also record video, audio, still photography, SMS, MMS, email, voice communications or other data being generated or received locally on the handset.

The local recording function 56 may be activated upon the activation of the application 14. Conversely, the local recording function 56 may be activated prior to the activation of the application 14. For example, if the user device 14 is connected to an external power source such as an AC outlet, the local recording function 56 may be activated prior to the activation of the application 14 and may, in fact, the local recording function 56 may always be activated when connected to the external power source. Alternatively, the local recording function 56 may be activated provided the remaining battery life of the user device 12 is above a certain charging level. In such an environment, the local recording function 56 may be continuous and the recordings buffered and/or cycled through memory so that a history of the recordings is always available. When the local recording function 56 is activated prior to the activation of the application 14, it is possible to set the time limits for the assimilation of the event data to extend both prior to and subsequent to the activation of the application 14. Alternatively, subsets of the local recording function 56, such as audio only or audio and video only with no GPS activation, may be enabled as a function of power connection or battery life.

Conversely, there may be an external recording function 64 which may record event data created externally to the user device 14. For example, the external recording function 64 may record weather information, event descriptions from a content server 30, social media communications between one or more users that are designated by the set attributes function 70 but do not include communications with the user device 14. The external recording function 64 may also reside in a camera or sound recorder remote from the user device 14, such as a traffic camera, a web-cam, video surveillance system or any other remote camera that is in communication with the user device 14. Apparatus performing the external recording function 64 may be connected to the user device across the cellular network, 20, a Wi-Fi network 22 or BLUETOOTH, NFC, or any other communication medium.

There may be a naming convention function 58 which may, for example, include common file names for easy access and assimilation by an application of a user. For example, a naming convention may include the event name, input type, sequence number, date, and time stamp. Thus, searching or assimilation by event name will assimilate, store and retrieve all data associated with an event, regardless of the input. Alternatively, searching or assimilation by event name and input time, i.e., video recordings, will assimilate, store and retrieve all video recordings associated with the event. Such a naming convention may be used for uniformity across multiple events and multiple users. It may also be used for efficient use of cloud storage and retrieval. In an aspect, there may be a storage destination function 60 which may designate event data storage in a cloud or locally on a user device 14, a server, or another storage medium.

There may be a weighting function 62 to permit certain event data being highlighted over other event data. For example, the weighting function 62 may assign a higher weight to video recordings than audio recordings due to the potential higher usage value of video data. Likewise, real time audio and video recordings may be assigned a higher weight than post event commentary in an email string. The weighting function 62 may assist a user in editing an application using the editing function 74 to create a more user-friendly retrieval and viewing experience. Alternatively, the weighting function 62 may be used to make more efficient use of storage where storage may be limited. The weighting function 62 may also assign a priority level to the event data based on relative importance or other objective or subjective criteria.

It will be understood that there may be other sensors on the user device 14 or in communication with the user device 14 that may be activated to record sensor data associated with the event data. For example, accelerometers on the user device 14 may be used to record movement including speed, direction, and rotation of the user device 14. The user device 14 may be connected to a vehicle such as an automobile and thereby have access to other sensors that are integral or attached to the automobile, such as performance sensors, black-box data, or other vehicle data.

In an aspect, there may be a digital rights management function 66 to control access and usage of the recorded event data. There may be other functions performed by the application running in either the user device 14 or one or more external devices or servers. The functional description and FIG. 2 is not intended to limit the disclosure.

In an aspect, application server 21 may control some or all of the application functions in coordination with user device 12 and may include profiles for collecting and storing event data. For example, application server may receive an activation command from the user device 12 and, send a set of data collection functions to the user device 12 for the user device 12 to effectuate. Such data collection functions may be those set forth above, including local audio and video recording, capturing location data, sensor data, voice communications and other functions that may be locally accessible and controllable from the user device 12. He application server may then receive first data collected by the data collection functions from the user device 12. The application server 21 may then request and receive second data collected during a time period from an external server, correlate the first data and the second data to form event data, and then cause the event data to be stored in a retrievable record. It is understood that the allocation of functions described herein is exemplary only and is non-limiting.

Operational Flow Diagram

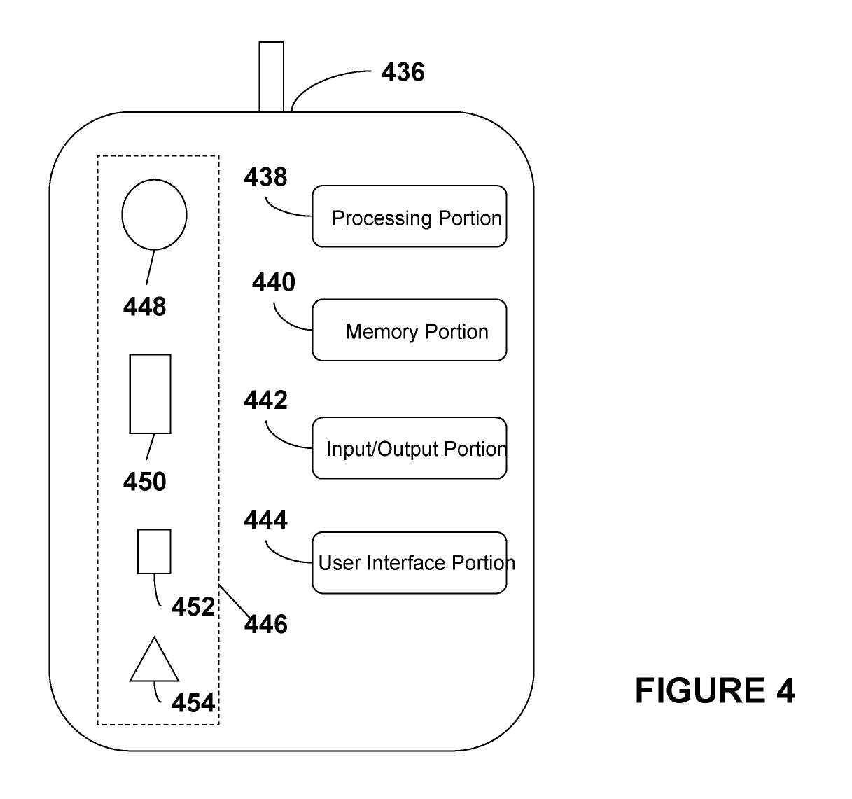

With reference to FIG. 4, there is shown an exemplary process flow diagram of the operation of the present disclosure. The process begins at 100 at which the application is activated. The activation may be accomplished by a voice command, the depression of a hardware switch or by activation of a soft-switch. At 102, the question as to whether there are custom-defined attributes are present. If not, default attributes are used at 104. If yes, the custom attributes are used. The attributes may include, but are not limited to, the time limits, the user device 14 functions, such as audio, video, or still camera functions, to be activated and recorded, the external servers 24 to be monitored, naming conventions, location data, and the like. At 104, the selected functions are turned on. At 108, the events are recorded, including audio, video, text, MMS, SMS. At 110, external events that have been designated for recording are identified and captured. Such external events may include weather, emergency situations such as flooding or earthquakes, or any other external event occurring generally contemporaneously with the event being recorded by the application. At 112, the recorded inputs and the external events data collected at steps 108 and 110, respectively, are assimilated into one or more records, along with naming conventions, data rights management, storage destination, and other data relating to the storage of the event data. At 114, the event data is stored at the designated storage destination.

Use Cases.

In accordance with the present disclosure, there are many uses cases for the application 14 described herein. For example, the event data captured in accordance with the system and method described above may be accessible from a web site or other social media platform, including, for example, ancestry.com. Family members and relatives may record event data and share the results online. The event data may, for example, be a birthday party or a wedding. In the event of a birthday party, the event data may include data captured from social media wishing the user a happy birthday, a recording of the birthday song, and a list of attendees. The wedding event data may include location, weather, external event data, audio, video, social media and other data. Each of the birthday party and the wedding may have its own digital rights management in which certain individuals or groups of individuals are provided access to retrieve and view the event data. A priority may also be assigned to each, with the wedding assigned a higher priority than the birthday party. As such, an authorized user may be able to apply search filters based on the particular naming convention, keywords such as “birthday party” or “wedding”, the dates of each, the locations of each, or the priority of each wherein a search for high priority events will return event data for the wedding but not necessarily for the birthday party.

Another use case may include recording event data surrounding an emergency situation. Upon activation, the location, audio, video, weather, speed, direction and other external event information, including external cameras connected to a security system, may be recorded, saved and assimilated and stored. Digital rights management may include authorized viewing by family members, law enforcement or first responders or perhaps the media. There may be a separate category of emergency event data with each event assigned a priority and key words for future retrieval filtering, such that authorized users may search for fire or any emergency with a high priority code associated therewith.

It will be understood that the foregoing use cases are exemplary only and are not intended to limit the scope of the disclosure or the claims. Such use cases may account for the collection and correlation of unique combinations of selected recordings and other internal and external event data to create event data upon the activation of an application 14 on a user device 12. By way of a non-limiting example, the correlation of local and external audio-video recording with SMS and/or MMS data messages is a unique combination of otherwise known elements integrated into an application 14. The correlation of data from the combination of other components that comprise event data from external servers 24 is likewise novel and unique when initiated and controlled by application 14, regardless of whether the functionality is performed entirely on a user device 12 or an application server 21 or a combination thereof.

Device Overview.

FIG. 4 is a block diagram of an example device 436 that may, for example be a smartphone or other mobile device and which is configurable to receive visual voice mail displays. The device 436 can include any appropriate device, mechanism, software, and/or hardware for distributing connectivity and/or transmission time as described herein. As described herein, the device 436 comprises hardware, or a combination of hardware and software. And, each portion of the device 436 comprises hardware, or a combination of hardware and software. In an example configuration, the device 436 can comprise a processing portion 438, a memory portion 440, an input/output portion 442, a user interface (UI) portion 444, and a sensor portion 446 comprising at least one of a video camera portion 448, a force/wave sensor 450, a microphone 452, a moisture sensor 454, or a combination thereof. The force/wave sensor comprises at least one of a motion detector, an accelerometer, an acoustic sensor, a tilt sensor, a pressure sensor, a temperature sensor, or the like. The motion detector is configured to detect motion occurring outside of the communications device, for example via disturbance of a standing wave, via electromagnetic and/or acoustic energy, or the like. The accelerator is capable of sensing acceleration, motion, and/or movement of the communications device. The acoustic sensor is capable of sensing acoustic energy, such as a noise, voice, etc., for example. The tilt sensor is capable of detecting a tilt of the communications device. The pressure sensor is capable of sensing pressure against the communications device, such as from a shock wave caused by broken glass or the like. The temperature sensor is capable of sensing a measuring temperature, such as inside of the vehicle, room, building, or the like. The moisture sensor 54 is capable of detecting moisture, such as detecting if the device 436 is submerged in a liquid. The processing portion 438, memory portion 440, input/output portion 442, user interface (UI) portion 444, video camera portion 448, force/wave sensor 450, and microphone 452 are coupled together to allow communications there between (coupling not shown in FIG. 9).

In various embodiments, the input/output portion 442 comprises a receiver of the device 36, a transmitter of the device 436, or a combination thereof. The input/output portion 442 is capable of receiving and/or providing information pertaining to visual voice mail messages as described herein or other communications with other devices and device types. For example, the input/output portion 442 can include a wireless communications (e.g., 2.5G/3G/4G) SIM card. The input/output portion 442 is capable of receiving and/or sending text information, video information, audio information, control information, image information, data, an indication to initiate a connection, an indication to initiate a transmission, start time information, end time information, interval time information, interval length information, random number value information, connect time information, transmit time information, parsing information, authentication information, or any combination thereof. In an example configuration, the input\output portion 442 comprises a GPS receiver. In an example configuration, the device 36 can determine its own geographical location through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 442 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion comprises a WIFI finder, a two way GPS chipset or equivalent, or the like.

The processing portion 438 is capable of processing the event capture application as described herein. The processing portion 438, in conjunction with any other portion of the device 436, enables the device 436 to covert speech to text or convert text to speech.

In a basic configuration, the device 436 can include at least one memory portion 440. The memory portion 440 can store any information utilized in conjunction with visual voice mail as described herein. Depending upon the exact configuration and type of processor, the memory portion 40 can be volatile (such as some types of RAM), non-volatile (such as ROM, flash memory, etc.). The device 436 can include additional storage (e.g., removable storage and/or non-removable storage) including, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or the like. In an example configuration, the memory portion 440, or a portion of the memory portion 440 is hardened such that information stored therein can be recovered if the device 436 is exposed to extreme heat, extreme vibration, extreme moisture, corrosive chemicals or gas, or the like. In an example configuration, the information stored in the hardened portion of the memory portion 440 is encrypted, or otherwise rendered unintelligible without use of an appropriate cryptographic key, password, biometric (voiceprint, fingerprint, retinal image, facial image, or the like). Wherein, use of the appropriate cryptographic key, password, biometric will render the information stored in the hardened portion of the memory portion 440 intelligible.

The device 436 also can contain a UI portion 444 allowing a user to communicate with the device 436. The UI portion 444 is capable of rendering any information utilized in conjunction the visual voice mail as described herein. For example, the UI portion 444 can provide means for entering text (including numbers), entering a phone number, rendering text, rendering images, rendering multimedia, rendering sound, rendering video, receiving sound, or the like, as described herein. The UI portion 444 can provide the ability to control the device 436, via, for example, switchs, soft keys, voice actuated controls, a touch screen, movement of the device 436, visual cues (e.g., moving a hand in front of a camera on the mobile device 436), or the like. The UI portion 444 can provide visual information (e.g., via a display), audio information (e.g., via speaker), mechanically (e.g., via a vibrating mechanism), or a combination thereof. In various configurations, the UI portion 444 can comprise a display, a touch screen, a keyboard, a speaker, or any combination thereof. The UI portion 444 can comprise means for inputting biometric information, such as, for example, fingerprint information, retinal information, voice information, and/or facial characteristic information. The UI portion 444 can be utilized to enter an indication of the designated destination (e.g., the phone number, IP address, or the like).

In an example embodiment, the sensor portion 446 of the device 436 comprises the video camera portion 448, the force/wave sensor 450, and the microphone 452. The video camera portion 448 comprises a camera (or cameras) and associated equipment capable of capturing still images and/or video and to provide the captured still images and/or video to other portions of the device 436. In an example embodiment, the force/wave sensor 450 comprises an accelerometer, a tilt sensor, an acoustic sensor capable of sensing acoustic energy, an optical sensor (e.g., infrared), or any combination thereof.

Although not every conceivable combination of components and methodologies for the purposes describing the present disclosure have been set out above, the examples provided will be sufficient to enable one of ordinary skill in the art to recognize the many combinations and permutations possible in respect of the present disclosure. Accordingly, this disclosure is intended to embrace all such alterations, modifications and variations that fall within the spirit and scope of the appended claims. For example, numerous methodologies for defining triggering events for activation of sensor technologies including onboard video cameras to record risky driving behavior may be encompassed within the concepts of the present disclosure.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

While example embodiments have been described in connection with various computing devices/processors, the underlying concepts can be applied to any computing device, processor, or system capable of recording events as described herein. The methods and apparatuses for recording and reporting events, or certain aspects or portions thereof, can take the form of program code (i.e., instructions) embodied in tangible storage media having a physical structure, such as floppy diskettes, CD-ROMs, hard drives, or any other machine-readable storage medium having a physical tangible structure (computer-readable storage medium), wherein, when the program code is loaded into and executed by a machine, such as a computer, the machine becomes an apparatus for distributing connectivity and/or transmission time. A computer-readable storage medium, as described herein is an article of manufacture, and thus, is not to be construed as a transitory signal. In the case of program code execution on programmable computers, which may, for example, include server 40, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems of the present disclosure may be practiced via communications embodied in the form of program code that is transmitted over some transmission medium, such as over electrical wiring or cabling, through fiber optics, wherein, when the program code is received and loaded into and executed by a machine, such as an EPROM, a gate array, a programmable logic device (PLD), a client computer, a controller, or the like, the machine becomes an apparatus for use in reconfiguration of systems constructed in accordance with the present disclosure. When implemented on a general-purpose processor, the program code combines with the processor to provide a unique apparatus that operates to invoke the functionality described herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method comprising:
activating an application wherein the application resides on a device having voice and data communications;
responsive to the receiving step, determining, by the application, a set of data collection functions to initialize;
responsive to the determining step, initializing, by the application, the data collection functions;
correlating data, by the application, captured by the data collection functions to create event data; and
causing, by the application, the event data to be stored in a retrievable record.

2. The method of claim 1 further comprising:
responsive to the activating step, determining, by the application, a location and wherein the correlating step includes correlating the location with the event data.

3. The method of claim 1 further comprising:
Setting, by the application, a time period wherein data from the data collection functions is time-stamped and the correlating step correlates data during the time period.

4. The method of claim 3 wherein the time period includes a first time period prior to the receiving step and a second time period after execution of the receiving step.

5. The method of claim 4 further comprising initiating an audio or video recording function during the first time period and wherein the audio or video recording comprises a portion of the event data.

6. The method of claim 5 wherein the initiating step is performed as a function of one of remaining battery life in a user device and a connection of the user device to an AC power source.

7. The method of claim 6 further comprising determining, by the application, a location and wherein the correlating step includes correlating the location with the event data.

8. The method of claim 3 further comprising recording a voice communication initiated within the time period wherein the recording of the voice communication forms a portion of the event data.

9. The method of claim 1 further comprising activating wi-fi communications and recording a MAC address and wherein the MAC address forms a portion of the event data.

10. The method of claim 1 wherein the activating step includes initializing a local recording function and an external recording function and the correlating step includes correlating the recordings created by the local recording function and the external recording function with the event data.

11. The method of claim 1 further comprising prioritizing the event data for subsequent retrieval.

12. A device having voice and data communications, comprising:
an activation switch;
an input/output system for communicatively coupling the device to an input device and a storage source, the input/output system configured to provide audio and data communications;
a processor communicatively coupled to the input/output system; and
memory storing instructions that cause the processor to effectuate operations, the operations comprising:
in response to actuation of the activation switch,
determining a set of data collection functions to initialize;
responsive to the determining step, initializing the data collection functions;
correlating data captured by the data collection functions to create event data; and
causing the event data to be stored in a retrievable record.

13. The device of claim 12 wherein the operations further comprises setting a time period wherein the time period includes a first time period prior to the receiving step and a second time period after execution of the receiving step.

14. The device of claim 13 wherein the operations further comprise initiating an audio or video recording function during the first time period and wherein the audio or video recording comprises a portion of the event data.

15. The device of claim 14 wherein the initiating step is performed as a function of one of remaining battery life in the device and a connection of the device to an AC power source.

16. The device of claim 15 wherein the operations further comprise determining a location and wherein the correlating step includes correlating the location with the event data.

17. The device of claim 13 wherein the operations further comprise recording a voice communication initiated within the time period wherein the recording of the voice communication forms a portion of the event data.

18. The device of claim 12 wherein the operations further comprise activating a wi-fi communications and recording a MAC address and wherein the MAC address forms a portion of the event data.

19. The device of claim 12 wherein the initializing step includes initializing a local recording function and an external recording function and the correlating step includes correlating the recordings created by the local recording function and the external recording function with the event data.

20. An application server comprising:
an input/output system for communicatively coupling the server to a user device and a storage source;
a processor communicatively coupled to the input/output system; and
memory storing instructions that cause the processor to effectuate operations, the operations comprising:
receiving an activation command from the user device;
sending a set of data collection functions to the user device;
receiving first data collected by the data collection functions wherein the first data includes voice data collected from the user device;
receiving second data collected during a time period from an external server correlating the first data and the second data to form event data;
causing the event data to be stored in a retrievable record.
